(19) United States
(12) Patent Application Publication
(10) Pub. No.: US 2009/0071315 A1
(43) Pub. Date: Mar. 19, 2009

(54) Music analysis and generation method

(76) Inventor: Joseph A. Fortuna, Lake Huntington, NY (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 12/151,278

(22) Filed: May 5, 2008

Related U.S. Application Data
(60) Provisional application No. 60/927,998, filed on May 4, 2007.

(51) Int. Cl. G10H 7/00

(52) U.S. Cl. 84/609

(57) ABSTRACT

A system for the creation of music based upon input provided by the user. A user can upload a number of musical compositions into the system. The user can then select from a number of different statistical methods to be used in creating new compositions. The system utilizes a selected statistical method to determine patterns amongst the inputs and creates a new musical composition that utilizes the discovered patterns. The user can select from the following statistical methods: Radial Basis Function (RBF) Regression, Polynomial Regression, Hidden Markov Models (HMM) (Gaussian), HMM (discrete), Next Best Note (NBN), and K-Means clustering. After the existing musical pieces and the statistical method are chosen, the system develops a new musical composition.

### CROSS REFERENCE TO RELATED APPLICATION

This application is based upon and claims benefit of copending and co-owned U.S. Provisional Patent Application Ser. No. 60/927,998 entitled “Music Analysis and Generation Method”, filed with the U.S. Patent and Trademark Office on May 4, 2007 by the inventor herein, the specification of which is incorporated herein by reference.

### BACKGROUND OF THE INVENTION

1. Field of the Invention

The present invention relates generally to data processing, pattern recognition and music composition. In particular, the invention provides an automated method of data regression and generation to produce original music compositions. The system utilizes existing musical compositions provided by a user and generates new compositions based upon a given input.

2. Background

Although the spirit out of popular music has slowly eroded over the last several years, there exists an excellent industry-rooted motivation for research towards discovering an elusive “pop formula.” While the reward for discovering such “pop formula” may be great, research on this field, up to date, has not utilized popular music songs to create new compositions.

Much of the work done thus far in computational composition has been quite respectful of the role of the human being in the process of composition. From Lejaren Hiller (Hiller, L. & L. Isaacson, 1959, Experimental Music, McGraw Hill Book Co. Inc.) to David Cope (Cope, D., 1987, Experiments in Music Intelligence, Proceedings of the International Music Conference, San Francisco: Computer Music Ass'n.) and Michael Mozer (Mozer, M., Neural Network Music Composition by Prediction: Exploring the Benefits of Psychoacoustic Constrains and Multiscale Processing, Connection Science, 1994), researchers have likened their use of machinery in the creation of original works to the use that any artist makes of an inanimate tool. Hiller states this clearly:
“my objective in composing music by means of computer programming is not the immediate realization of an esthetic (sic) unity, but the providing and evaluation of techniques whereby this goal can eventually be realized. For this reason, in the long run I have no personal interest in using a computer to generate known styles either as an end in itself or in order to provide an illusion of having achieved a valid musical form by a tricky new way of stating well-known musical truths.”
   However, compositional researchers, such as Hiller, Cope, and Mozer, have drawn from corpora of complex musical forms-almost exclusively pieces of classical (or at least traditional and historic) origin.

The field of research into computational methods of musical analysis and generation is quite broad. Early efforts towards the probabilistic generation of melody involved the random selection of segments of a discrete number of training examples (P. Pinkerton, Information Theory and Melody, Scientific American, 194:77-86, 1956). In 1957, Hiller, working with Leonard Isaacson, generated the first original piece of music made with a computer—the “Illiac Suite for String Quartet.” Hiller improved upon earlier methods by applying the concept of state to the process, specifically the temporal state represented in a Markov chain. Subsequent efforts by music theorists, computer scientists, and composers have maintained a not-to-distant orbit around these essential approaches-comprehensive analysis of a musical “grammar” followed by a stochastic “walk” through the rules inferred by the grammar to produce original material, which (it is hoped) evinces both some degree of creativity and some resemblance to the style and format of the training data.

In the ensuing years, various techniques were tried ranging from the application of expert system, girded with domain-specific knowledge encoded by actual composers to the model of music as auras of sound whose sequence is entirely determined by probabilistic functions (I. Xenakis, Musiques Formelles, Stock Musique, Paris, 1981).

The field enjoyed a resurgence in the 80's and 90's with the widespread adoption of the MIDI (Musical Instrument Digital Interfaces) format and the accessibility that format provides for composers and engineers alike to music at the level of data. In the world of popular music, the growth in popularity of electronica, trance, dub, and other forms of mechanically generated music has led to increased experimentation in computational composition on the part of musicians and composers. Indeed, in the world of video games, the music composed never ventures further than the soundboards of computers on which it is composed. As far as the official record goes, however, even given all of the research that has gone into automatic composition and computer-aided composition, in the world of pop (which is a world of simple, catchy, ostensibly formulaic tunes) there is still no robotic Elvis or a similar system that allows for the composition of such musical pieces.

A search of the prior art uncovers systems that are designed to develop musical compositions as continuations of single musical inputs. These systems utilize single musical compositions as templates for a continuation of the melody, but do not create new compositions based upon the original input. Other systems utilize statistical methods for morphing one sound into another. While these systems utilize more than one input, their output is merely a new sound that begins with the original input and evolves into the second input. Such a basic system lacks the ability to create completely new compositions from more complex input such as a pop song. Other systems allow for the recognition of representative motifs that repeat in a given composition, but they do not create completely new compositions. As a result, there is a need for a system that can utilize multiple advanced compositions, such as pop songs, to create new musical pieces.

### SUMMARY OF THE INVENTION

The present invention provides a system for the creation of music based upon input provided by the user. A user can upload a number of musical compositions into the system. The user can then select from a number of different statistical methods to be used in creating new compositions. The system utilizes a selected statistical method to determine patterns amongst the inputs and creates a new musical composition that utilizes the discovered patterns. The user can select from the following statistical methods: Radial Basis Function (RBF) Regression, Polynomial Regression, Hidden Markov Models (HMM) (Gaussian), HMM (discrete), Next Best Note (NBN), and K-Means clustering. After the existing musical pieces and the statistical method are chosen, the system develops a new musical composition. Lastly, when the user selects the “Listen” option, the program plays the new composition and displays a graphical representation for the user.

The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 illustrates a graphical user interface (GUI) that can be used in one embodiment of the present invention.

FIG. 2 illustrates an output from the use of the polynomial regression method.

FIG. 3 illustrates the musical score of a composition created utilizing the polynomial regression method.

FIG. 4 illustrates a graphical output from training utilizing the Radial Basis Function (RBF) method at sigma 2.

FIG. 5 illustrates a graphical output from training the system utilizing the RBF Regression method at sigma 122.

FIG. 6 illustrates a graphical depiction of a first order Markov Model.

FIG. 7 illustrates a graphical depiction of a Hidden Markov Model.

FIG. 8 illustrates a graphical output of the NBN method trained on five songs.

FIG. 9 illustrates a graphical output of the NBN method trained on all the songs uploaded into one embodiment of the present invention.

FIG. 10 illustrates the NBN method trained on two melodies.

FIG. 11 illustrates an output from the K-means clustering method.

FIG. 12 illustrates an output of a combination of the K-means clustering and HMM discrete methods.

FIG. 13 illustrates the musical score of an output obtained utilizing Hidden Markov Models.

FIG. 14 illustrates the difference between the musical score of an original piece and the modified score of the same song after being modified for use in one embodiment of the present invention.

### DESCRIPTION OF EXEMPLARY EMBODIMENTS

The invention summarized above and defined by the enumerated claims may be better understood by referring to the following description, which should be read in conjunction with the accompanying drawings. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

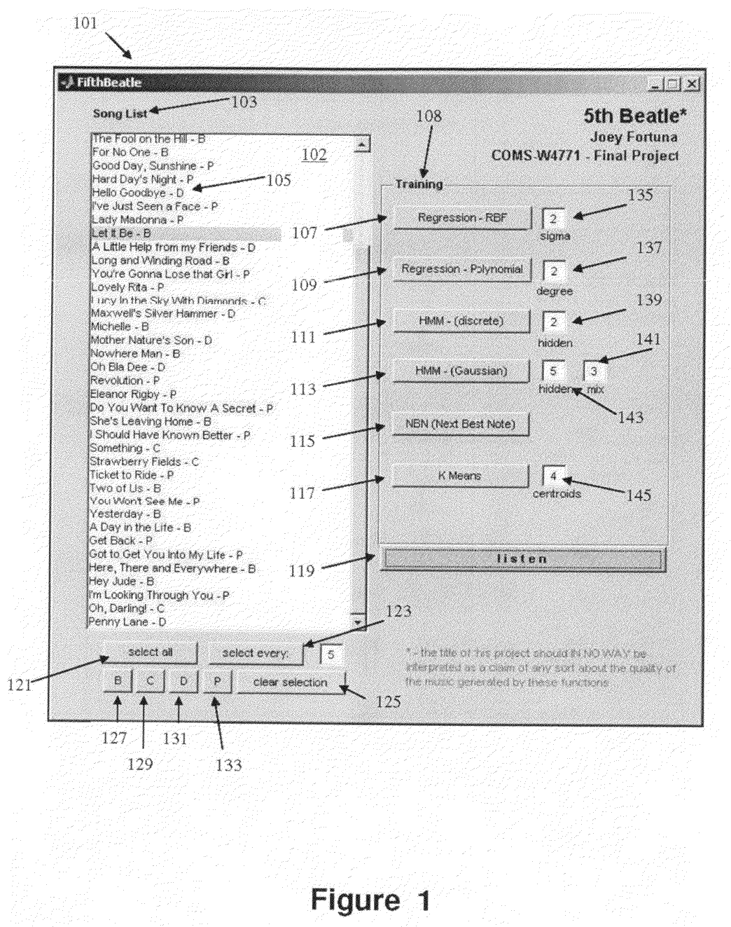

In an effort to solve the above-described problem, a computer application for the automatic composition of musical melodies is provided. FIG. 1 illustrates a graphic user interface (GUI) 101 in a computer system for one embodiment of the present invention. A user can upload one or more musical melodies 105 into the application. These compositions 105 are uploaded after being encoded into the MIDI format. Any available software program designed for the purpose of encoding music into MIDI format can achieve the conversion. The uploaded musical melodies 105 are displayed in a window 102 entitled “song list” 103. Each musical composition 105 that is uploaded may be given a designated identifier such as B, C, D, or P. These identifiers can relate to different categories assigned by the user, such as the type of musical genre or melody, e.g. ballad, pop, classical, characteristic, ditty, and others. A different embodiment of the invention can have additional identifiers, a single identifier, or no identifier at all.

The user can then select the melodies that will be utilized to train the system. The user can select a melody one at a time or all the melodies using a single button 121. The user can also instruct the system to select songs that appear on the list at specific times using another button 123, such as selecting every fifth song on the list to compile the training set. The user can also instruct the system to utilize only songs belonging to a designated identifier using separate buttons, such as B 127, C 129, D 131, or P 133, as the training set for creating a new composition.

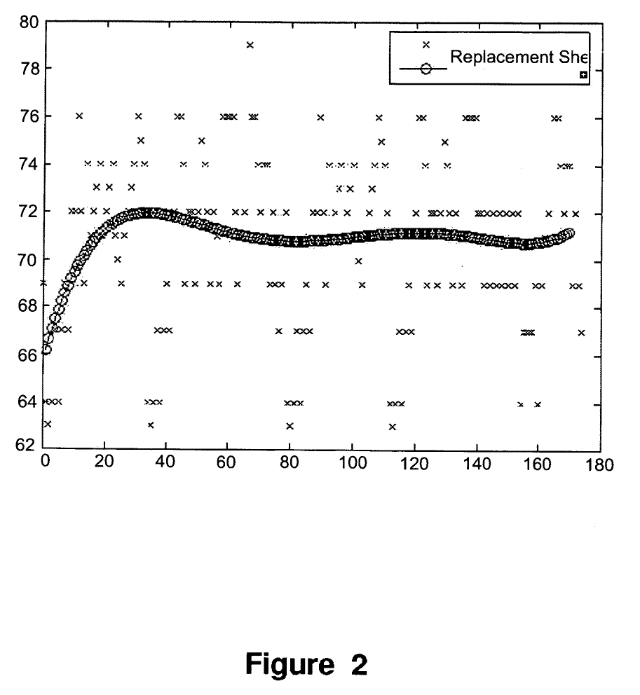

Once the user selects the training set from the song list 103, a specific training 108 approach can be selected. A number of buttons are provided so the user can choose from a number of training methods: Regression-RBF 107, Regression-Polynomial 109, HMM (discrete) 111, HMM (Gaussian) 113, NBN (Next Best Note) 115, or K Means 117. Each of these training methods is described in further detail below. Once the training method is selected, the user can specify parameters for the selected method, such as the number of standard deviations, “sigma” 135, the number of standard deviations or “degree” 137, the number of discrete hidden states 139, the number and mix of hidden states 141, 143, or the number of centroids to consider 145. Having been given the inputs, the system is trained and produces an output file. A suitable programming language such as Python is used to translate the sequence of integers contained in the output file into a playable MIDI file. The newly created MIDI file can then be launched from the GUI 101. The file is launched by selecting the “listen” 119 option. The MIDI file then is played through any audio peripheral compatible with the system and a graphical representation of the training results can be presented to the user as shown in FIGS. 2, 4, 5, 8, 9, 10, 11, and 12.

The output of the new song generation process is a file that can be stored in a subfolder of the application directory tree, or any location selected by the user. As stated previously, that file can then be translated into a MIDI file that can also be stored at a specific location in the application directory tree or a location selected by the user. Some embodiments of the present invention can allow the user to select locations for storage of the output file, the MIDI file, both files, or neither file. Some embodiments of the present invention allow the user to specify the name of the MIDI file. Other embodiments do not allow the user to specify the name of the file. If the embodiment does not allow the user to select a new name for the file, the file will be overwritten with every use of the application or given a generic name that changes when the application is subsequently utilized. When the user is ready to select a new training set, the user may clear the previous selections by selecting the “clear selection” button 125.

The output files are generated through a variety of different methods as shown in FIG. 1. The Polynomial Regression 109 button on the GUI 101 allows the user to take advantage of a straightforward statistical analysis using multidimensional regression to create a new musical composition. With this model, it is assumed that the dataset conforms to some as-yet-unknown pattern that can be approximated by applying nonlinear transformation to a sequence of inputs. The goal of this process is to devise some optimum parameter θ that, when applied in a polynomial function to the input, produces something approximating the observed output.

In this method, a standard least squares measurement is used for the estimation of empirical risk −R(θ). As a result, θ minimizes to:

$$R ( Θ ) = \frac{1}{2 N} {‖ y - X Θ ‖}^{2} \qquad ( 1 )$$

Where N is the number of samples in the training set, y is a vector of outputs, X is a D-dimensional matrix of N rows of input, and θ represents the coefficient parameters used. In some embodiments, the variable X (representing the sequence of pitches) is unidimensional. To elevate the resulting equation from its simplistic linear output, a feature space of non-linear equations φ is introduced, which is applied to each input. Therefore, the dimensions of X become the value of Xᵢ (for each i in φ) as transformed by each φᵢ. Under this model, Equation (1) becomes:

$$R ( Θ ) = \frac{1}{2 N} {‖ y - Θ Φ ( X ) ‖}^{2} \qquad ( 2 )$$

The minimization of θ is accomplished by computing the gradient ∇R of Equation 2 (essentially, taking partial derivatives of the equation), setting to zero and solving for θ. The resulting equation (in matrix form) simplifies as:

Θ=(X^{T}X)⁻¹X^{r}y (3)

Equation (3) is simply the pseudo inverse of matrix X multiplied by the output vector y.

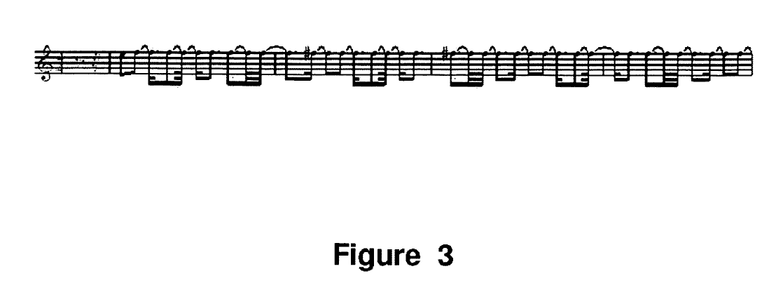

The first feature vector (which can be implemented and tested by setting the parameters and pressing the “Regression Polynomial” 109 button in the GUI 101) is simply an array of functions that successively raise the degree of each xᵢ to the power of each i for each φᵢ in the feature space. As an input parameter, the Regression Polynomial function 109 accepts an integer value for its “sigma” component 135. FIGS. 2 and 3, described in greater detail below, provide an example of the graphical display and musical score that result from utilizing the Regression Polynomial method.

Another method is the Radial Basis Function (RBF) Regression that can be selected by using the button 107 on the GUI 101. This method is more versatile than the basic Regression Polynomial. The RBF Regression generally takes the form of some weight multiplied by a distance metric from a given centroid to the data provided. In one embodiment of the present invention, the function utilized is Gaussian providing a normal distribution of output over a given range. As an input parameter, the RBF function 107 accepts an integer value for its “sigma” component or degree 137, which corresponds to the width of the Gaussian function involved. This function is represented by the formula:

$$\frac{1}{( 2 {σ}^{2} )} exp ‖ x - {x}_{i} ‖ \qquad ( 4 )$$

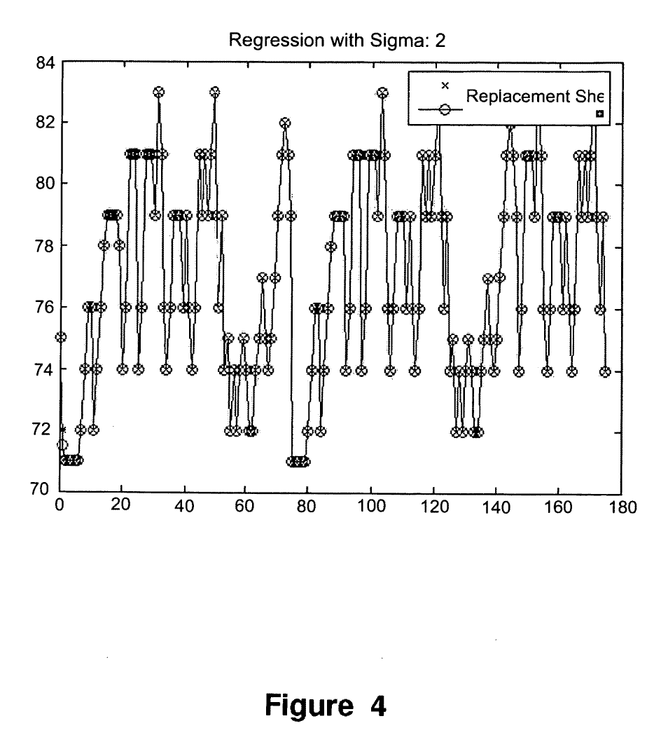

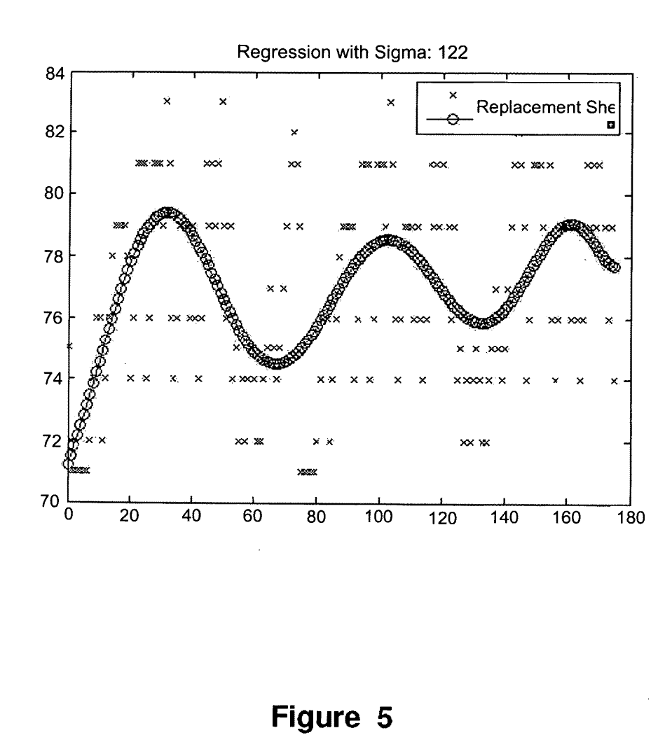

An RBF Regression has the advantage of being more flexible than the simple polynomial regression because it takes into account its distance from the data at every point (centroid here corresponding to the individual input data points). This is an additive model, meaning that the output from each function is “fused” with the output of each succeeding and preceding function to generate a smoother graph. At smaller values of sigma, the output provides an accurate representation of the input. FIG. 4, described in greater detail below, shows an example of an output graph using this method at sigma 2. At higher values for sigma, the graph tends to look increasingly like a sinusoidal function. FIG. 5, described in greater detail below, shows an example of an output graph using this method at sigma 122. In both cases, RBF Regression provides accurate models for a given song.

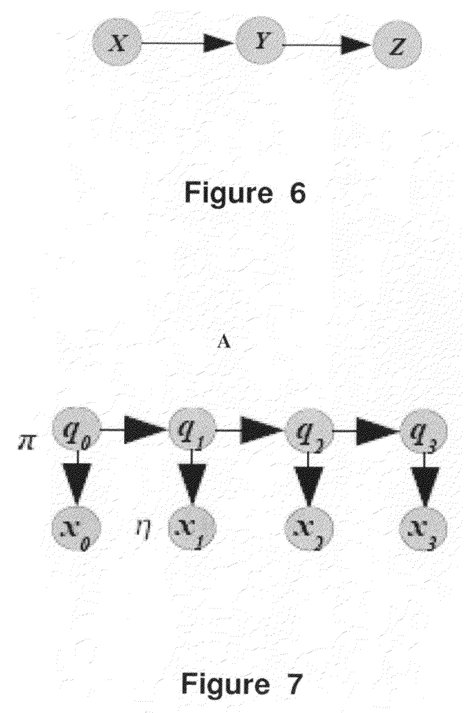

The next available method for music generation utilizes Hidden Markov Models (HMM) both discrete and Gaussian, which can be selected by buttons 111 and 113. The Markov model has been used widely in the field of natural language recognition and understanding. The general Markov principle provides that the future is independent of the past, given the present. Although this principle may appear to be dismissive of the concept of history, it implies a strong regard for the temporal nature of data. FIG. 6 provides a graphical representation of a first order Markov model. The meaning of this representation in probabilistic terms is that the Z is independent of X given Y, which is to say that the output of the node Z is completely dependent on the output of node Y. The first order Markovian principle has regard only for the t-1th node among any T nodes indexed 1 . . . t.

Inherent in this structure, however is the conditional probability of node Z given node Y. Mathematically, this is presented as: P(Z|Y). For the model shown in FIG. 6, the joint probability of the entire graph—p(X,Y,Z) is given as:

p(X,Y,Z)=p(X)p(Y|X)p(Z|Y) (5)

In contrast, this model differs from a probabilistic model in which the output of any node is equally likely—the case in which the entire set of outputs is independently and identically distributed (typically, and often cryptically, referred to as IID):

p(X,Y,Z)=p(X)=p(Y)p(Z) (6)

It is often the case, when reviewing data for statistical analysis, that certain data points are observed and others remain unknown to us. This situation gave rise to the concept of the Hidden Markov Model, in which an n-th order Markovian chain stands “behind the scenes” and is held responsible for a sequence of outputs.

As an imaginary-world example, consider the Wizard of Oz (Baum, L. Frank, The Wonderful Wizard of Oz, George M Hill, Chicago and N.Y. 1900). The flaming head and scowling visage of the Wizard in the grand hall of Emerald city can be seen as occupying any of a sequence of output states X={x₁, x₂, x₃, . . . , xₙ} where x, (for example) is his chilling cry of “SILENCE!” at the protestations of the Cowardly Lion. Meanwhile, the diminutive and somewhat avuncular figure of the old gentleman from Kansas, who stands frantically behind the curtain, yanking levers and pulling knobs, can be seen as occupying any of a number of “hidden” states Q={q₁, q₂, q₃} which give rise to the output states mentioned above.

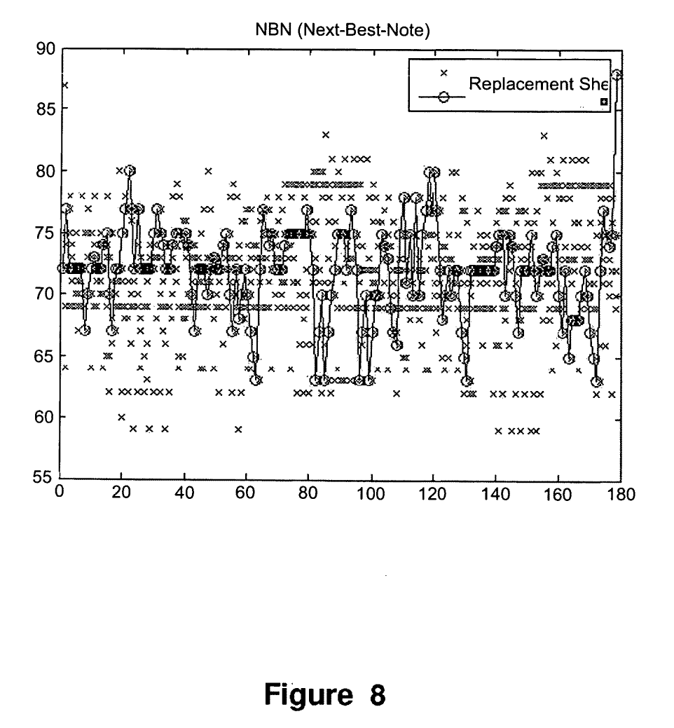

In this case, the old gentleman's transition from one state q₁ to the next state qₜ₊₁ is governed by a matrix of transition probabilities, which is typically chosen to be homogeneous (meaning that the probability of transition from one state to the next is independent of the variable t). A graphic illustration of this model can be found in FIG. 7, where in addition to the transition matrix of transition probabilities A, which governs the transitions between hidden states, there is typically an array of transition probabilities η, which determine the likelihood of output x, given the current state q. Finally, there is generally some measure of probability assigned to the start state q₀, which is traditionally indicated by the symbol π.

The joint probability for the model is therefore given by:

$$p ( q , x ) = {π}_{q 0} {\prod }_{t = 0}^{T - 1} {a}_{q t , q t + 1} {\prod }_{t = 0}^{T} p ( {x}_{t} \vert {q}_{t} ) \qquad ( 7 )$$

The essential idea of the HMM is that we can determine likelihood of a given hidden state sequence and output sequence by assuming that there is a “man behind the curtain” at work in generating the sequence.

A classic example illustrates the principle embodied in the present invention. One can determine the probability of drawing a sequence of colored balls from a row of urns, each of which contain a specific number of differently-colored balls, if one knows how many of each color is in each urn, and the likelihood of moving from one urn to the next. Similarly, one can determine the probability of each urn containing a certain number of each color if one is shown enough sequences and told something about the probability of transitioning from urn to urn. (See Rabiner, Lawrence, A Tutorial on Hidden Markov Models and Selected Applications in Speech Recognition, Proceedings of the IEEE, Vol. 77, No. 2, February 1989). As a result, generally, if one knows the number of hidden states, and the likelihood of moving from one hidden state to the next, and one knows the probability of emitting a given output symbol for each hidden state, then the world of the model is uncovered.

The HMM is a powerful tool for analyzing seemingly random sequences of emissions. In one embodiment of the present invention, the emission states correspond to a sequence of pitches. The preferred embodiment of the present invention estimates the transition matrix and then, given a set of training examples or emission sequences (the notes in the training songs), estimates the probabilities of emissions. The resulting model is then utilized to generate new data.

As shown in FIG. 1, in one embodiment of the present invention, the user has the ability to select the HMM (discrete) 111 or HMM (Gaussian) 113 models and provide the number of hidden states 139, 141, and 143, to be utilized in the calculations. An HMM toolbox is utilized to estimate the transition and emission probabilities using an Expectation-Maximization (EM) algorithm. (For one of such toolboxes see Murphy, Kevin, HMM Toolbox for MATLAB, 1998 available at http://www.cs.ubc.ca/˜murphyk/Software/HMM/hmm.html). The discrete version of the HMM 111 assumes that there is a static and discrete number of outputs and the Gaussian approach 113 assumes that these outputs result from a collection of Gaussian mixing components.

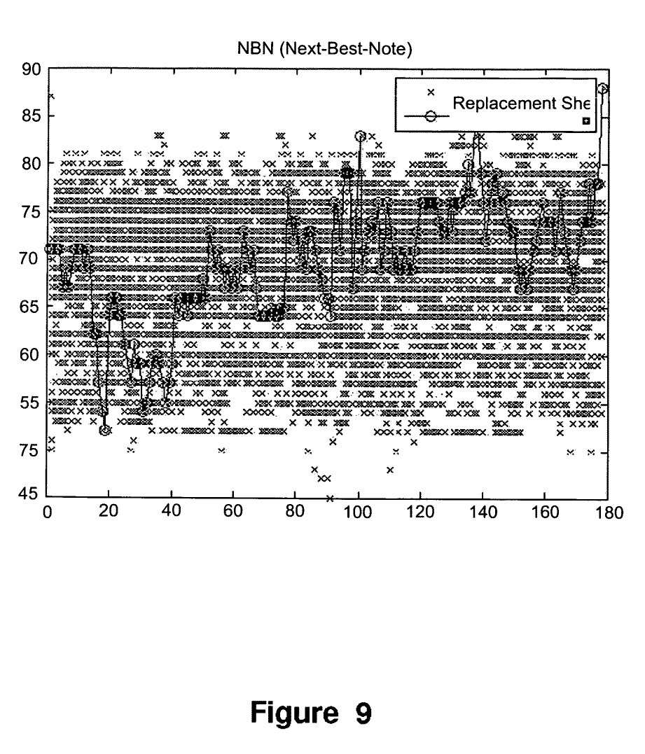

Another technique utilized in one embodiment of the present invention is the Next Best Note (NBN). The NBN technique can be selected using button 115. In this approach, a kind of virtual grammar is induced from the dataset, examining at each point of the song, the next most likely position given the current position. This can be viewed as a first order Markovian approach. The interesting aspect of this model is that the generated output tends to represent the original dataset more faithfully. In addition, it provides an improved training strategy across multiple songs. In this approach, a matrix of N×177 is created where N is the number of songs in the training set and 177 is the normalized song length. Each song is encoded with a fixed “start note” that is outside the range of notes present in any of the songs. The application then stochastically selects from among the most common next notes. This process continues for each selected note until the end of the song. FIGS. 8, 9 and 10, explained in greater detail below, provide examples of the output of the use of the NBN method in one embodiment of the present invention.

Another technique utilized to create new melodies is the K-means clustering 117, as shown in FIG. 1. This technique takes advantage of recognized patterns within each dataset utilized for training. The K-means algorithm is used to identify specific segments of the input songs and then train HMMs on each of the segments separately. The K-means algorithm clusters datapoints based on an initial guess for k centroids, which are then updated by iterative comparisons to the dataset. (As an input parameter, the K-means algorithm function 117 accepts an integer value for its initial number of centroids 145). At each iteration, for each of Xε{x₁, x₂, . . . , x_{N}} datapoints, a multinomial variable Z=z₁^{m}=z₂^{m}, . . . , z_{N}^{m} is updated in such a way that zᵢ^{m}=1 if a centroid μₘ is closest to the datapoint xᵢ and zᵢ^{r}=0∀r≠m. The centroids are then updated to be:

$${μ}_{m} = \frac{{\sum }_{i}^{N} {z}_{i}^{m} {x}_{i}}{{\sum }_{i}^{N} {z}_{i}^{m}} \qquad ( 8 )$$

The process continues to convergence. In one embodiment of the present invention, the algorithm is run twenty times, choosing from among the twenty results the centroids that produce the minimum value for J where J is determined as the sum across all points and all centroids of the Euclidean distance of the points to the centroids, or:

$$J = {\sum }_{m = 1}^{k} {\sum }_{i = 1}^{N} {‖ x - {μ}_{m} ‖}^{2} \qquad ( 9 )$$

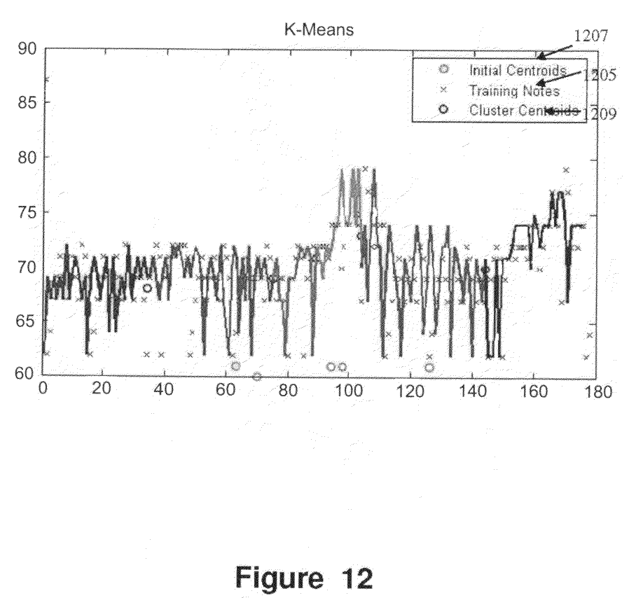

The user of one embodiment of the present invention can specify the number of clusters/centroids 145 he or she would like to examine. After identifying the clusters, each segment is fed to the discrete HMM, which generates output based on its estimation. The K-means algorithm according to the present invention identifies a certain segmentation within the song and the HMM (at its finer level of granularity) is able to extract intra-segment patterns that yield more aesthetically pleasing melodies. As described below, FIGS. 11, 12, and 13, illustrate examples of the output from the use of this method.

### EXAMPLES

While the present invention can be used in the traditional approach (i.e. the production of music utilizing complex musical forms of classical—or at least historic—origin), it can also function by drawing from a very different corpus, i.e. popular music. One dataset utilized by the present invention consists of 46 pieces of pop music written by the Beatles (excepting Sir Ringo Starr). Given this dataset, ostensibly much reduced in complexity and theoretically possessing of a tangible formulaic quality, the present invention demonstrates that truly aesthetic pop songs (to the ear of a human listener) can be generated using a variety of statistical techniques.

As shown on FIG. 1, the song list 103 can be created by uploading songs encoded into the MIDI format. In the present example, the songs used for training were originally written by some permutation of set B, where B={John Lennon, Paul McCartney, George Harrison}, and encoded by Herve Excourolle and Dominique Patte (they can be found at http://h.escourolle.free.fr/htm/gui_e.htm). The instrumentation from each of the songs is removed using a commercially available program such as Noteworthy Composer™ (available at http://noteworthycomposer.com), preserving only the melody. The songs are classified into four different categories, as shown in FIG. 1: B 127 for ballads, C 129 for characteristic (meaning characteristic to the Beatles' distinctive style), D 131 for ditty, and P 133 for pop.

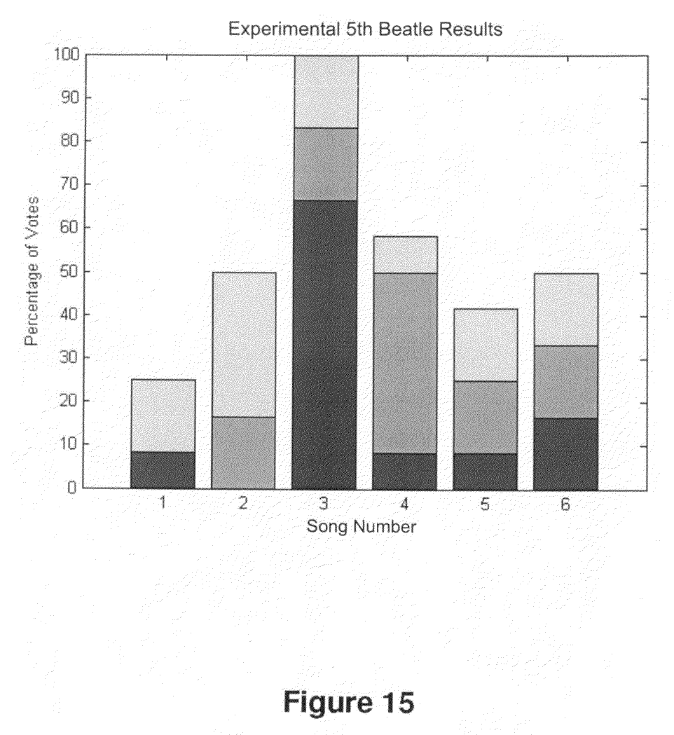

The songs are normalized using an open source library (such as that found at http://www.mxm.dk/products/public/pythonmidi) of MIDI conversion and decoding tools. The songs are normalized, as explained earlier, by reducing the note count to the lowest common denominator (177), applying uniformity to note duration (each note is transformed to an eighth note, regardless of previous duration). FIG. 14 depicts the difference between the original melody score 1401, in this case the first line of the melody from “Let It Be,” and that created by the normalization process 1402. The songs are transposed into the key of C Major to guarantee uniformity across the training set. The normalized training set is then utilized to create a new melody.

A graphical depiction of the output of the system utilizing the Polynomial Regression method 109 trained at degree 6 with the song “When I'm 64” is shown in FIG. 2. FIG. 3 shows the musical score of the output using the Polynomial Regression method 109. FIG. 4 represents a graphical depiction of the RBF Regression method 107 at sigma 2 utilizing the song “The Fool on the Hill.” FIG. 5 represents the same RBF Regression method 107 at sigma 122 utilizing the same melody.

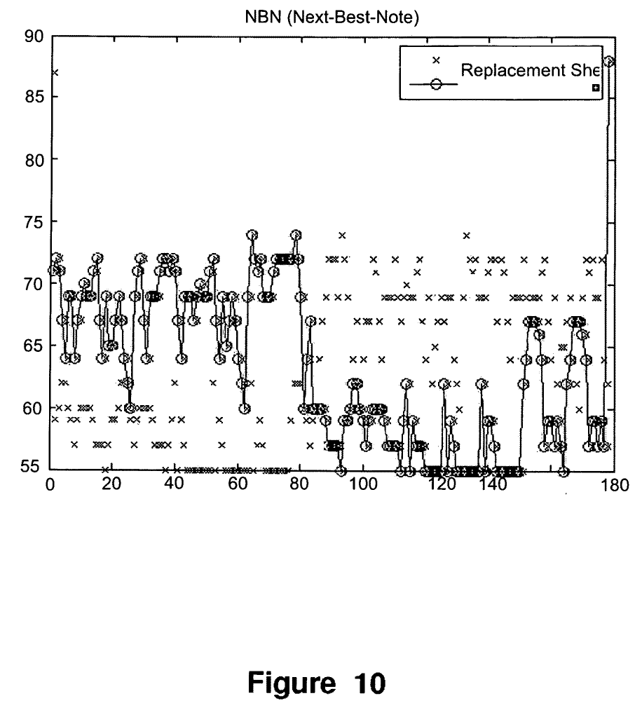

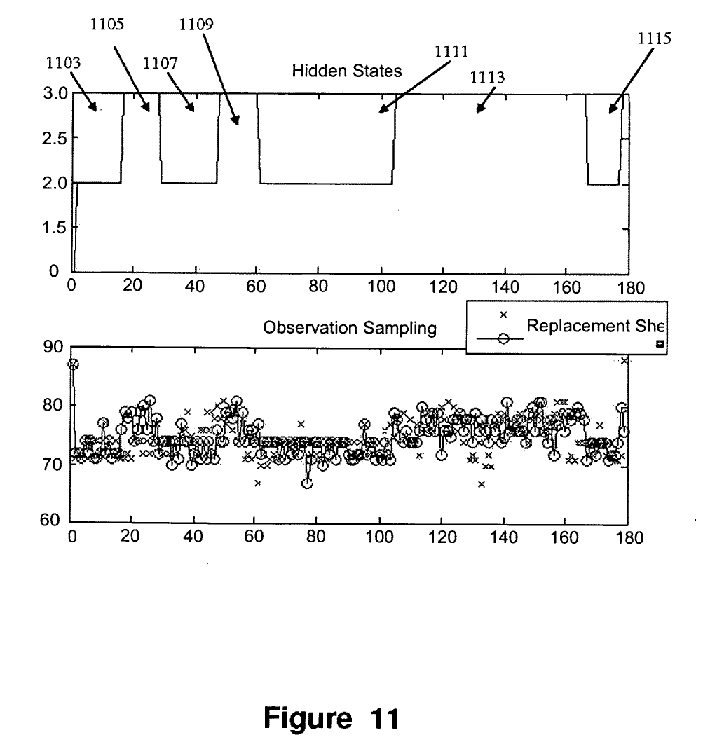

FIG. 8 is a depiction of the resulting melody obtained utilizing the NBN method 115 outlined previously. In this example, the system was trained on five songs. FIG. 9 represents the NBN method 115 in which all the songs in the song list 103 were utilized for training. Finally, FIG. 10 provides a depiction of the output of the Next Best Mode method 115 trained on “A Little Help From My Friends” and “Long and Winding Road.” In the Next Best Note method 115, like the RBF Regression model at sigma 2, a perfect duplicate of the input is generated when utilizing only one song as training material. As the number of songs in the training set increases, the output created is more different.

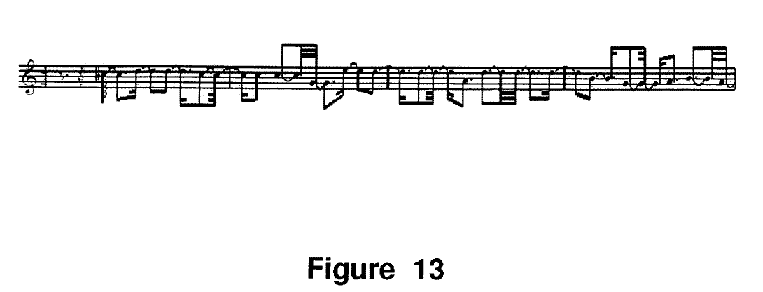

FIG. 11 represents a graphical depiction of the K-means clustering method 117. The HMM was trained on the song “Hard Day's Night,” which was truncated to 177 notes, and the several states (1103, 1105, 1107, 1109, 1111, 1113, 1115) roughly translate to a switch between the verse and either the chorus of the song or the bridge (“When I'm home/everything seems to be right/when I'm home I feeling you holding me tight/tight, yeah.”). FIG. 12 represents a combination of the K-means method 117 and HMM (discrete) method 111. The display includes the initial centroids 1207, the training notes 1205, and the cluster centroids 1209. The initial centroids 1207 are those provided by the user in the GUI 101 shown in FIG. 1 at 145. The cluster centroids 1209 are those calculated by the program utilizing the K-means clustering method described previously.

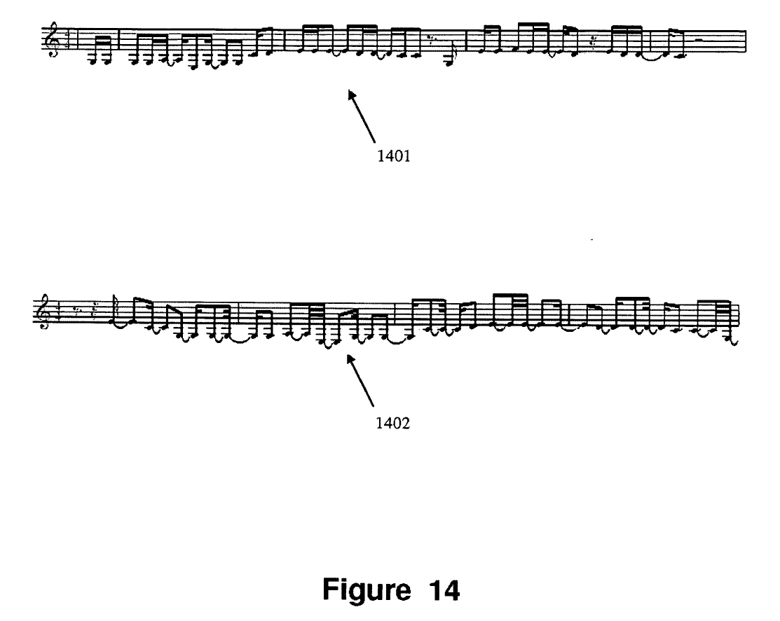

FIG. 13 shows the HMM output from training on “Across the Universe.” A visual examination of the musical output of this example reveals a substantial level of complexity. This output tends to be melodic as it is statistically aware of which notes it should produce and where the notes should go, given its input.

The invention has been described with references to exemplary embodiments. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It should be understood, therefore, that the invention may be practiced otherwise than as specifically set forth herein. Consequently, the present embodiments are to be considered in all respects as illustrative and not restrictive.

What is claimed is:

1. A method of generating a musical composition, comprising:
a) providing a digital database comprising a plurality of digital song files;
b) selecting at least one song from said database for training;
c) selecting a training approach; and
d) using statistical methods based upon the selected training approach, creating an output file comprising a new song file.

2. The method of generating a musical composition of claim 1, wherein said training approach is selected from the group consisting of:
RBF Regression;
Polynomial Regression;
Next Best Note;
Hidden Markov Model-discrete;
Hidden Markov Model-Gaussian; and
K-means.

3. The method of generating a musical composition of claim 1, wherein said plurality of digital song files comprises MIDI files.

4. The method of generating a musical composition of claim 1, wherein said output file comprise a playable song file.

5. The method of generating a musical composition of claim 4, wherein said output file comprises a MIDI file.

6. The method of generating a musical composition of claim 4, wherein said output file can be stored in a user selectable location.

7. The method of generating a musical composition of claim 1, wherein songs in said plurality of song files are coded by genre.

8. The method of generating a musical composition of claim 7, said step of selecting at least one song from said database further comprising:
selecting said at least one song based on a selected genre.

9. The method of generating a musical composition of claim 1, said step of using statistical methods based upon the selected training approach to create an output file further comprising:
determining patterns in said at least one song from said database; and
creating a new musical composition using said patterns.
